(19) United States
(12) Patent Application Publication
(10) Pub. No.: US 2016/0365739 A1
(43) Pub. Date: Dec. 15, 2016

(54) BATTERY INTERRUPTER

(71) Applicant: Stephen Lewis, New York, NJ (US)

(72) Inventor: Stephen Lewis, New York, NJ (US)

(21) Appl. No.: 14/737,572

(22) Filed: Jun. 12, 2015

(51) Int. Cl. H02J 7/00

(52) U.S. Cl. CPC H02J 7/0045; H02J 7/0052; H02J 2007/0096

(57) ABSTRACT

A battery interrupter that allows a user to assert control over a device that was not designed to be operated different from its original function is provided for. It permits an external device to take control of the power train of a device, primarily battery-operated, by regulating the flow of energy through the device, and acting thusly as an external management system. This external system can be as simple as a wired remote control switch to turn it on and off, or as complex as a wireless communication system that provides access to programming languages, internet data, and other types of rule-based and real-time management and interaction.

### CLAIM OF PRIORITY

This application claims no priority to any previous patent or patent application.

### FIELD OF THE EMBODIMENTS

This invention relates to a battery interrupter and its method of use. In particular, this invention related to a device that enables the wireless or wired control of a battery-operated device, regardless of whether that battery-operated device was designed to be controlled externally.

### BACKGROUND OF THE EMBODIMENTS

A large percentage of the toys that have been produced in the past few decades operate via power generated from batteries. The inclusion of batteries allows the toy to engage in some sort of movement, and frequently provides for greater entertainment that the toy's non-powered alternative. Aside from toys, a large number of other devices operate via primary batteries, such as digital cameras, flashlights, remotes, and a wide variety of other devices.

These devices are all designed with a specific purpose, which is furthered by the use of power. However, while these devices can perform a many different functions through the utilization of battery power, many of these devices, particularly toys, are only capable of two states; powered on and powered off. Further, many of these devices require a specific amount of power to operate in a given way. For example, take a dog toy that when in operation will walk forward. In order to use this toy, one must pick the toy up, flip the power switch, orient the toy, and then allow it to walk in the direction upon which it was oriented. When a user desired the toy to stop moving forward, the user must walk over to where the toy is, pick it back up, and flip the power switch to the off position.

All of this work merely to get a toy to move forward a distance and then stop seems unnecessary, particularly when the toy's movement is a function of a single variable; the amount of power flowing through its circuits. Thus, there is a need for a device that allows for the external operation of a battery-operated device, which can be incorporated into any device that uses a standard primary battery.

Examples of related art are described below:

U.S. Pat. No. 6,837,739 discloses a battery located inside an enclosure. An actuatable shim is inserted between the battery and at least one contact. The shim may be conductive on at least one face to provide a switch function, or may be non-conductive face.

U.S. Patent Publication No. 2013/0112539 discloses a removable circuit interrupter equipped with circuit-testing capabilities. In one embodiment, a removable circuit interrupter is provided for use with a battery-powered device. The battery-powered device includes a battery and a load that is electrically coupled to the battery and the removable circuit interrupter is configured to be disposed between the battery and the load. The removable circuit interrupter includes a conductive layer and a non-conductive layer on the opposite side. The conductive layer is configured to electrically coupled to one of the battery and the load. The non-conductive layer is configured to electrically couple to another one of the batteries as well as the load.

U.S. Patent Publication No. 2008/0231233 discloses a power charging system which includes a power converter unit and a selectively detachable battery charger module. This module is configured to receive power from the remote power converter unit and also receive and charge a rechargeable battery or batteries. The battery charger module is a stand-alone accessory to be used with the power converter unit, which is also adapted to power and/or charge a portable electronic device.

International Patent Application No. WO 2014/066272 discloses a remote control device that may be configured to be mounted over the toggle actuator of a light switch and to control a load control device via wireless communication. The remote control device may include a control circuit and a wireless communication circuit. The control circuit may be operably coupled to the rotating portion and to the wireless communication circuit. The control circuit may be configured to translate a force applied to the rotating portion of the remote control device into a control signal and transmit that signal to the load control device.

U.S. Pat. No. 6,426,887 discloses a remote control receiving device mounted on an apparatus having a switch circuit and an LED. The switch circuit is connected between a power supplied circuit and a power source. The LED receiving element receives an optical signal from a transmitting device. When the apparatus turns into a standby state based on an optical signal from a transmitting device, the switch circuit is brought into OFF by a microcomputer in the remote control receiving device. When the LED receives an optical signal from the transmitting device, the LED outputs an electric control signal to turn on the switch circuit. Thereby, power is supplied to the apparatus.

U.S. Patent Publication No. 2014/0273867 discloses an apparatus, system, and method for communicating with a battery-powered electronic device having a wireless receiver. There, the receiver is power-cycled once every predetermined time period. The method comprises, determining a power cycle time of the battery-powered electronic device, defining a transmission time duration equal to or greater than the power cycle time, storing the transmission time duration in a memory, and transmitting a signal intended for the battery-powered electronic device, the signal lasting for at least the transmission time duration.

U.S. Pat. No. 7,298,240 discloses a device that has an electronic key that transmits a wireless coded signal and at least one tool that can receive that signal. The coded signal is compared to a coded signal stored in said tool. If the coded signal matches the stored signal, a switch is closed for a predetermined amount of time. After the predetermined amount of time, the switch is opened so that the tool can no longer be used.

U.S. Pat. No. 8,558,487 discloses a remote-controlled circuit breaker for battery powered riding toys and method of using is disclosed. The circuit breaker is capable of being installed into standard electrical systems of battery powered riding toys via complementary connectors. If the child encounters danger while riding, the handler of the remote control can push the “Stop” button to switch the circuit breaker. Later, the handler of the remote control can push the “Go” button, allowing movement of the vehicle.

U.S. Pat. No. 8,341,275 discloses systems and methods for remote access of network-enabled devices. This access provides seamless, firewall-compliant connectivity between multiple users and multiple devices that allow collaborative operations by multiple users of remote devices, that allow point to multipoint control of multiple devices, and which allow rapid, secure transmission of data between remote users and devices. In general terms, the system includes at least one connection server, and at least two computers operatively coupled to the connection server via a public or global network.

### SUMMARY OF THE EMBODIMENTS

The present invention provides for a battery interrupter, comprising: a double-sided electrical contact; an electrical circuit connection in electronic communication with said double-sided electrical contact; and a circuit board, in electronic communication with said electrical circuit connection, said circuit board comprising: a memory, a processor, a wireless transceiver, and a battery connector. This transceiver will be capable of transmitting and receiving signals in the Bluetooth, Wi-Fi, radio, IR, RF, satellite, and microwave protocols. In an alternative embodiment, the present invention is capable of externally controlling a battery-operated device via a wired connection.

In an alternative embodiment, the present invention comprises everything listed above, as well as a second double-sided electrical contact; and a second electrical circuit connection in electronic communication with said second double-sided electrical contact and with said circuit board. In this alternative embodiment, the battery connector is optional as the two double-sided contacts are capable of completing the circuit without the use of the battery connector.

In yet another alternative embodiment, the circuit board of the present invention is contained in a case, which is affixed to the object to be controlled and the electrical circuit connection and second electrical circuit connection are long enough to allow the case to be mounted, via a fastening mechanism, in a wide variety of places.

The present invention also contemplates a method of wirelessly controlling a non-internet-enabled electronic device, comprising the steps of: providing a non-internet-enabled battery-operated device; inserting a double-sided electrical contact next to one terminal of a battery inserted into said non-internet-enabled, battery-operated device, wherein said double-sided electrical contact is in electronic communication with an electrical circuit connection, and said electrical circuit connection is connected to a circuit board, comprising: a memory, a processor, an electronic communication mechanism, and a battery connector; powering said non-internet-enabled, battery-operated device; wirelessly controlling the flow of energy from said battery, via said circuit board by varying the duty cycle of the power.

It is an object of the present invention to provide a means to control a battery-operated device wirelessly.

It is an object of the present invention to toggle the power of a toy.

It is an object of the present invention to provide new functionality to old battery-operated toys.

It is an object of the present invention to provide a device that does not need a separate power source.

### BRIEF DESCRIPTION OF THE DRAWINGS

FIG. 1 shows a top view of an embodiment of the apparatus of the present invention.

FIG. 2 shows a bottom view of an embodiment of the apparatus of the present invention.

FIG. 3 shows a perspective view of an embodiment of the apparatus of the present invention, while in use.

FIG. 4 shows a perspective view of an alternative embodiment of the apparatus of the present invention.

FIG. 5 shows a perspective view of another alternative embodiment of the apparatus of the present invention, while in use.

FIG. 6 shows a perspective view of an embodiment of the apparatus of the present invention, while in use.

FIG. 7 shows a perspective view of another embodiment of the apparatus of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Although this invention has been described with a certain degree of particularity, it is to be understood that the present disclosure has been made only by way of illustration and that numerous changes in the details of construction and arrangement of parts may be resorted to without departing from the spirit and the scope of the invention.

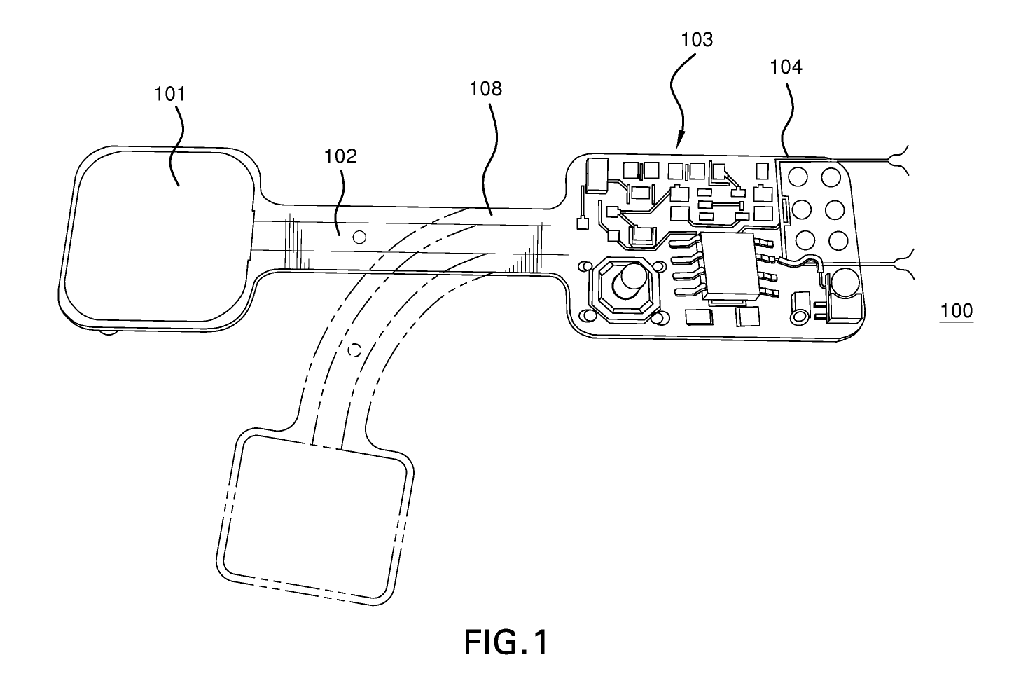

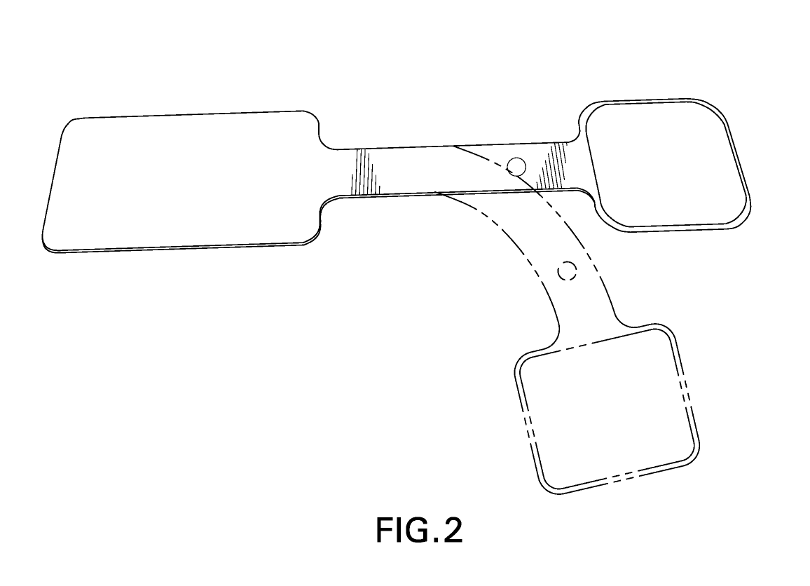

Referring to FIG. 1, a top view of an embodiment of the apparatus of the present invention is provided for. Here, battery interrupter 100 is shown. Battery interrupter 100 is comprised of double-sided electrical contact 101, electrical circuit connection 102, circuit board 103, flexible connector 108, and wireless transceiver 104. Double-sided electrical contact 101 is inserted next to one terminal of a battery while battery connector 105 (See FIG. 2) is inserted next to an oppositely charged battery terminal. Double-sided electrical contact 101 is in electronic communication with circuit board 103 which operates wireless transceiver 104. In one embodiment, battery interrupter 100 is operated via an internet-enabled electronic device, such as a mobile phone, a tablet, or some sort of computer. In a preferred embodiment, electrical circuit connection 102 is enclosed or enveloped by flexible connector 108. In yet another preferred embodiment, flexible connector 108 is an insulator. This characteristic allows for a more-uniform flow of electricity throughout the present invention and will reduce the likelihood of short-circuiting the present invention. FIG. 1 also shows the flexible nature of said flexible connector.

The apparatus of the present invention allows a user to assert control over a device that was not designed to be operated different from its original function. It permits an external device to take control of the power train of a device, primarily battery-operated, by regulating the flow of energy through the device, and acting thusly as an external management system. This external system can be as simple as a remote control switch to turn it on and off, or as complex as a communication system that provides access to programming languages, internet data, and other types of rule-based and real-time management and interaction. Note that in most embodiments, battery interrupter 100 is not equipped with a power supply because it harvests energy from the host battery directly.

Multiple communications protocols are proposed in this device to permit a single external control system to address a multitude of battery-operated devices in a given field. Additionally, the present invention contemplates these devices being able to communicate with each other, such that they may be operated in tandem, or in a complimentary fashion, as a user desires. Adding this functionality will enhance a user's enjoyment of classical toys that were not intended to be operated in that way.

Referring to FIG. 2, a bottom view of an embodiment of the apparatus of the present invention is provided for. In a preferred embodiment, the present invention further comprises an integrated battery connector that attaches to one terminal of a host battery, wherein said battery connector is integrated into the circuit board of the present invention.

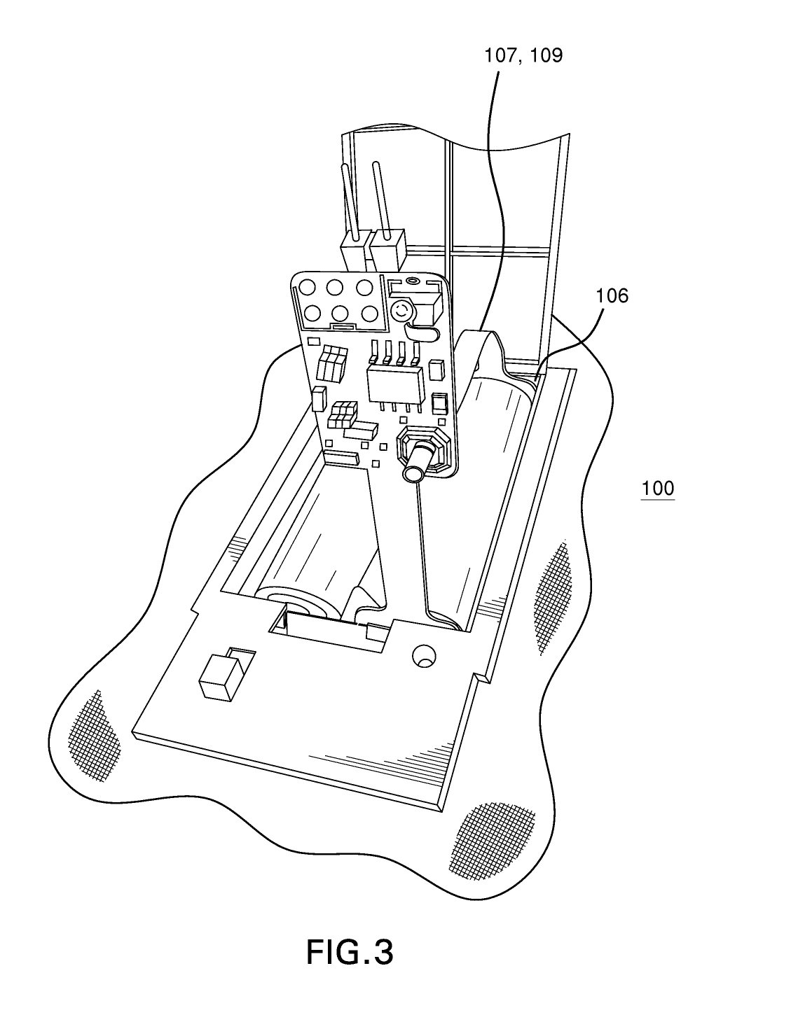

FIG. 3 shows a perspective view of an embodiment of the apparatus of the present invention, while in use. Here, battery interrupter 100 is equipped with second double-sided electrical contact 106, second electrical circuit connection 107, and second flexible connector 109. In this particular embodiment, double-sided contact 101 and second double-sided contact 106 can be used in conjunction to appropriately integrate battery interrupter 100 into the circuitry of a battery-operated device.

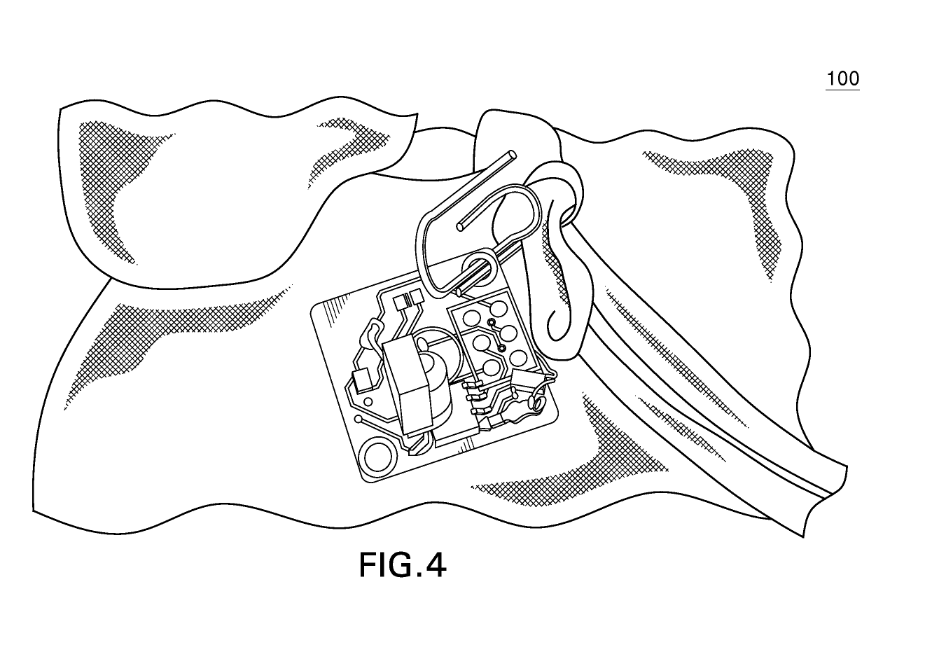

Referring to FIG. 4, a perspective view of an alternative embodiment of the apparatus of the present invention is provided for. Here, an alternative embodiment of battery interrupter 100 is shown. Here, battery interrupter 100 is not equipped with flexible connector 108 (See FIG. 1) or second flexible connector 109 (See FIG. 3), and instead, electrical circuit connection 102 (See FIG. 1) and second electrical circuit connection 107 (See FIG. 3) are elongated such that circuit board 103 may be mounted at a distance away from the battery terminal. This has the added benefit of opening up the possibilities of where the wireless transceiver may be located, allowing for easier remote operation of the device. In this particular embodiment, circuit board 103 may be affixed to a battery operated device via hook and loop fasteners, magnets, pins, hooks, and a number of other standard affixing devices.

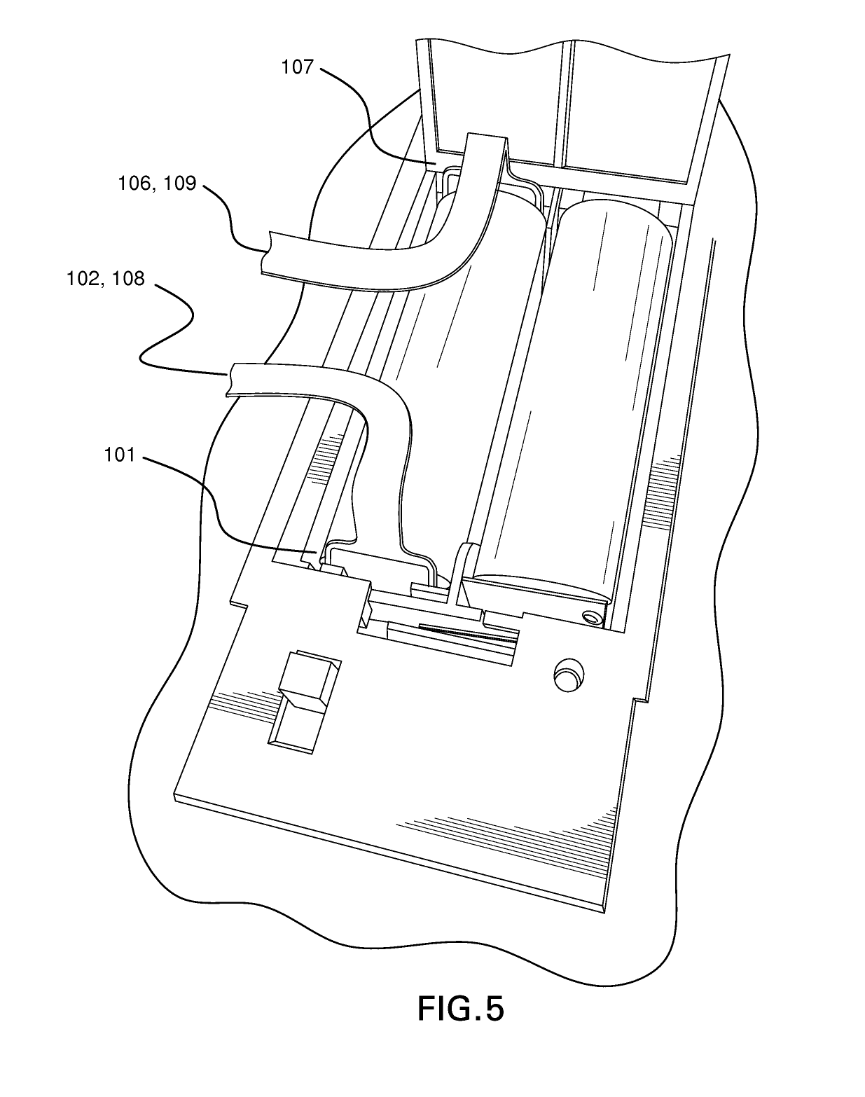

FIG. 5 shows a perspective view of another alternative embodiment of the apparatus of the present invention, while in use. This figure shows double-sided contact 101 and second double-sided contact 106, including electrical circuit connection 102 encompassed by flexible connector 108 and second electrical circuit connection 107 enveloped by second flexible connector 109. These components lead to circuit board 105 (See FIG. 4) which will control the flow of electricity in the battery-operated device by varying the duty cycle of the power. In a preferred embodiment, this is done in a substantially analog manner.

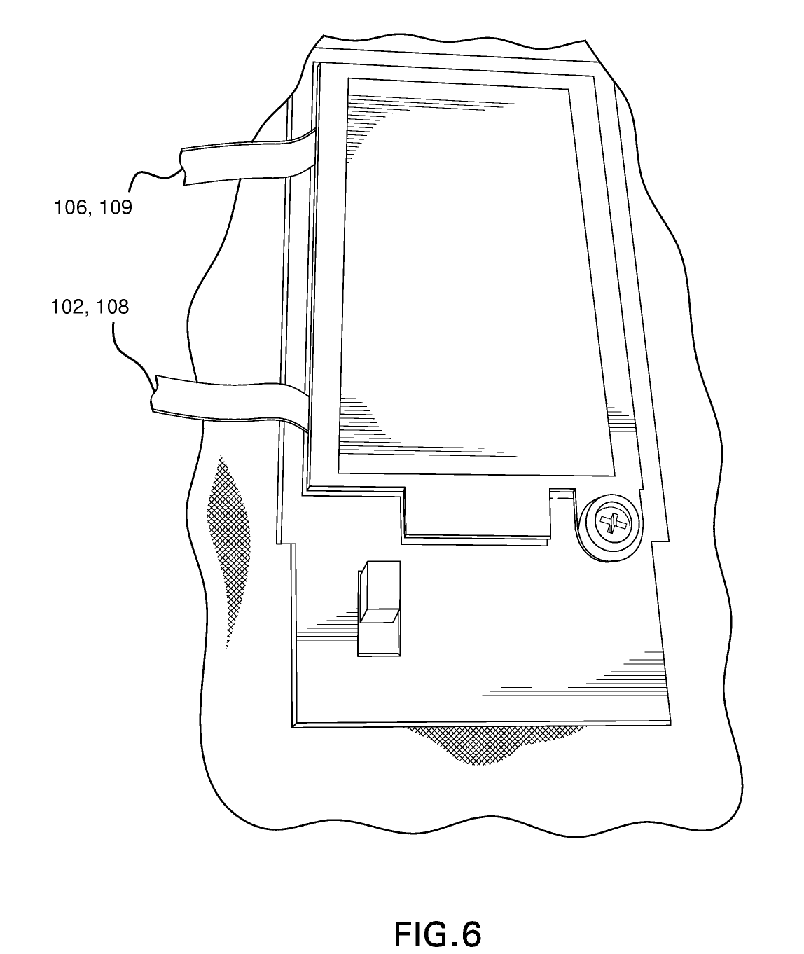

FIG. 6 shows a perspective view of this embodiment interfacing with a battery-operated device, except the cover surrounding the batteries of the battery-operated device is now closed. Here, electrical circuit connection 102 is shown elegantly tucked away. This is to show that it is possible for many embodiments of the present invention to interface with standard battery-powered devices in a non-obtrusive manner, since in a preferred embodiment the connecting flexible cable is so thin as to allow the battery compartment of the toy or device to be completely closed. As can be seen, electrical circuit connection 102 and second electrical circuit connection 107, when encompassed by flexible connector 108 and second flexible connector 109 are substantially flat.

In yet another preferred embodiment of the present invention, the battery interrupter is controlled via a wired connection to a wired control module. In this embodiment, the wireless transceiver is optional, but still preferably equipped. In such an embodiment, the present invention further comprises a wired control module (external switch), connected via a wired connection. This external switch may be comprised of a simple on-off switch, or may be comprised of more advanced controls. The wired connection of this embodiment can have a wide variety of lengths. It can be as short as one foot, but can be as long as a user desires, limited only be the ability of the wire to sufficiently conduct electricity across long distances.

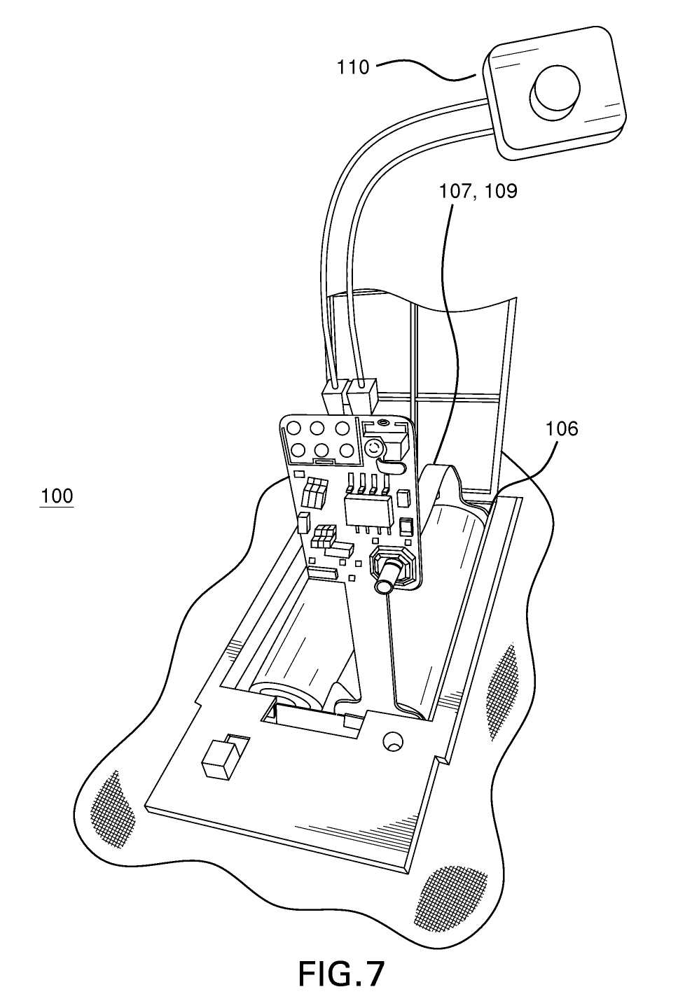

Referring to FIG. 7, another embodiment of the apparatus of the present invention is disclosed. This view shows an embodiment of the apparatus of the present invention that is highly similar to FIG. 3 in that battery interrupter 100 is equipped with second double-sided electrical contact 106, second electrical circuit connection 107, and second flexible connector 109. In this particular embodiment, double-sided contact 101 and second double-sided contact 106 can be used in conjunction to appropriately integrate battery interrupter 100 into the circuitry of a battery-operated device. However, in contrast for FIG. 3, the embodiment of FIG. 7 further comprises wired control module 110. Wired control module 110 may also be referred to as an external switch. Further, this can be used to control a battery-operated device in a manner consistent with the method of the present invention, however, the control is performed via a wired connection.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A battery interrupter, comprising:
a double-sided electrical contact;
an electrical circuit connection in electronic communication with said double-sided electrical contact; and
a circuit board, in electronic communication with said electrical circuit connection, said circuit board comprising:
a memory,
a processor, and
a wireless transceiver.

2. The battery interrupter of claim 1, further comprising:
a second double-sided electrical contact; and
a second electrical circuit connection in electronic communication with said
second double-sided electrical contact and with said circuit board.

3. The battery interrupter of claim 1, wherein said wireless transceiver is capable of receiving and transmitting signals selected from the group consisting essentially of: Bluetooth, Wi-fi, radio, IR, RF, satellite, and microwaves.

4. The battery interrupter of claim 1, further comprising a case,
wherein said case envelops said circuit board.

5. The battery interrupter of claim 4, further comprising a fastening mechanism attached to said case,
wherein said fastening mechanism is selected from the group consisting essentially of: hook and loop fasteners, pins, adhesives, and magnets.

6. The battery interrupter of claim 1, further comprising a wired control module.

7. The battery interrupter of claim 1, wherein said battery interrupter is in wireless communication with at least one additional battery interrupter of claim 1.

8. The battery interrupter of claim 1, further comprising an extension capable of controlling a flow of electricity.

9. The battery interrupter of claim 8, wherein said extension controls the flow of electricity by varying the duty cycle of the power.

10. The battery interrupter of claim 1, wherein said circuit board is constructed out of a flexible substrate.

11. The battery interrupter of claim 1, wherein said flexible substrate is Mylar.

12. The battery interrupter of claim 1, wherein said electrical circuit connection is enveloped by a flexible connector.

13. The battery interrupter of claim 2, wherein said electrical circuit connection and/or said second electrical circuit connection is enveloped by at least one flexible connector.

14. The battery interrupter of claim 12, wherein said flexible connector is an insulator.

15. The battery interrupter of claim 13, wherein said at least one flexible connector is an insulator.

16. A method of wirelessly controlling a non-internet-enabled electronic device, comprising the steps of:
providing, a non-internet-enabled, battery-operated device;
inserting, a double-sided electrical contact next to one terminal of a battery inserted into said non-internet-enabled, battery-operated device,
wherein said double-sided electrical contact is in electronic communication with an electrical circuit connection, and said electrical circuit connection is connected to a circuit board, comprising:
a memory,
a processor,
an electronic communication mechanism, and
a battery connector;
powering, said non-internet-enabled, battery-operated device;
wirelessly controlling the flow of energy from said battery, via said circuit board by varying the duty cycle of the power.

17. The method of claim 16, further comprising the step of inserting, a second double-sided electrical contact next to a second battery terminal.

18. The method of claim 16, wherein the step of wirelessly controlling the flow of energy from said battery is performed via an internet-enabled electronic device.

19. The method of claim 18, wherein said internet-enabled electronic device is selected from the group consisting of: a mobile phone, a tablet device, a laptop computer, a desktop computer, and a wearable computer.
